(19) United States
(12) Patent Application Publication
(10) Pub. No.: US 2007/0135093 A1
(43) Pub. Date: Jun. 14, 2007

(54) Mobile communication device having children's safe mode and method of operation thereof

(75) Inventors: Assaf Landschaft, Munich (DE); Gal Wohlstadter, Givataim (IL); Gil Wohlstadter, Givataim (IL)

Correspondence Address: HITT GAINES, PC;AGERE SYSTEMS INC., PO BOX 832570, RICHARDSON, TX, 75083, US

(73) Assignee: Agere Systems Incorporated, Allentown, PA (US)

(21) Appl. No.: 11/297,724

(22) Filed: Dec. 8, 2005

(51) Int. Cl. H04M 1/66

(52) U.S. Cl. 455/411

(57) ABSTRACT

A mobile communication device and a method of controlling the same to enable a children's safe mode. In one embodiment, the mobile communication device has a user input device, a user output device, a storage device configured to store digital data and a transceiver configured to communicate with a second communication device. The mobile communication device includes a user-activatable children's safe operating mode in which the mobile communication device is configured to: (a) inhibit user-activation of the transceiver, (b) inhibit user-alteration of user-defined data stored in the storage device and (c) cause the output device to provide pre-defined output data retrieved from the storage device in response to user input provided via the user input device.

### TECHNICAL FIELD OF THE INVENTION

The present invention is directed, in general, to wireless telecommunications and, more particularly, to a mobile communication device having a children's safe mode and a method of protecting a mobile communication device against unintended tampering.

### BACKGROUND OF THE INVENTION

Mobile communication devices, such as mobile telephones, personal digital assistants (PDAs) and personal digital assistants (MDAs) perform more useful functions today than ever before, including Internet browsing, text messaging, personal calendaring and even capturing still images and video. People have therefore come to rely on their constantly expanding functionality. For this reason, it is now commonplace for people to carry a mobile communication devices on their person at almost all times.

One unintended consequence of all of this use, however, is that nearby children become fascinated with the mobile communication devices. They want very much to play with them. It is a tempting proposition for parents, because they frequently are without entertaining toys for their children. But parents resist letting their own small children, e.g., aged 3-5 years, play with their mobile communication device. Several justifications underlie their position.

First, they are concerned that children might mistakenly change the mobile communication device settings. Frequently, even small changes in device settings can cause great confusion and take time to rectify.

Second, they are concerned that children may actually succeed in making a call. The greatest risk occurs with respect to numbers pre-programmed into the mobile communication device for fast dialing, such as those found in its phone directory, the last number dialed and community emergency numbers. The first two are potentially embarrassing or job-threatening. The last one may actually lead to a civil or criminal fine.

However, because they remain unaware of these risks, children continue to insist on playing with mobile communication devices, especially since at a certain age they know the difference between a real device and a toy.

Some measures have been taken to secure mobile communication devices against unwanted use. For example, U.S. Pat. No. 5,241,583 is directed to a portable radio telephone that has an electronic keypad lock function for locking the keypad to prevent accidental or unwanted actuation thereof. The keypad may be locked, for example, by performing a predetermined order of keystrokes.

However, while locking the keypad may provide the desired level of security, it significantly frustrates a child's play instincts. The result may be that the child begins to take its anger out on the mobile communication device, playing with it as though it were a rubber ball instead of a fragile electronic device. Disabling the keypad may therefore bring about distinctly unfortunate and destructive results.

What is needed in the art is a new mobile communication device that can be safely handed to a child and provides at least some semblance of functionality. What is further needed in the art is a way to provide at least some toy functionality to a mobile communication device without risking the unintended consequences described above.

### SUMMARY OF THE INVENTION

To address the above-discussed deficiencies of the prior art, the present invention provides, in one aspect, a mobile communication device. In one embodiment, the mobile communication device has a user input device, a user output device, a memory configured to store digital data and a transceiver configured to communicate with a second communication device. The mobile communication device includes a user-activatable children's safe operating mode in which the mobile communication device is configured to: (a) inhibit user-activation of the transceiver, (b) inhibit user-alteration of user-defined data stored in the memory and (c) cause the output device to provide pre-defined output data retrieved from the memory in response to user input provided via the user input device.

In another aspect, the present invention provides a method of controlling a mobile communication device having a user input device, a user output device, a memory configured to store digital data and a transceiver configured to communicate with a second communication device. In one embodiment, the method includes activating a user-activatable children's safe operating mode, the activating: (a) inhibiting user-activation of the transceiver, (b) inhibiting user-alteration of user-defined data stored in the memory and (c) causing the output device to provide pre-defined output data retrieved from the memory in response to user input provided via the user input device.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a schematic front view of one embodiment of a mobile communication device capable of operating in a children's safe mode in accordance with the principles of the present invention;

FIG. 2 illustrates a high-level block diagram of components of the mobile communication device of FIG. 1;

FIG. 3A illustrates a display of the mobile communication device of FIG. 1 showing a first screen associated with one embodiment of a children's safe mode carried out in accordance with the principles of the present invention;

FIG. 3B illustrates a display of the mobile communication device of FIG. 1 showing a second screen associated with one embodiment of a children's safe mode carried out in accordance with the principles of the present invention; and

FIG. 4 illustrates a flow diagram of one embodiment of a method of controlling a mobile communication device to provide a children's safe mode in accordance with the principles of the present invention.

### DETAILED DESCRIPTION

Described herein is one aspect of the present invention that takes the form of a mobile communication device, in particular a mobile telephone, a PDA or an MDA, having a user input device, a user output device, a memory configured to store digital data and a transceiver configured to communicate with a second communication device. The mobile communication device includes a user-activatable children's safe operating mode. In the user-activatable children's safe mode, the mobile communication device is configured such that: user-activation of the transceiver is inhibited, user-alteration of user-defined data stored in the memory is inhibited and the output device is caused to provide pre-defined output data retrieved from the memory in response to user input provided via the user input device.

In the children's safe mode, the mobile communication device on one hand is secured from mistakenly placing a call and from any unwanted change, i.e., for example to the mobile communication device's settings, phone directory entries or stored messages, but on the other hand is attractive for children since their input effects some attractive output. In fact, the children's safe mode may be even more attractive in terms of sights, sounds and vibrations than when not in the children's safe mode.

Typically, a keypad is provided as an input device. In one embodiment, each key of the keypad is associated with pre-defined output data which is output when the corresponding key is pressed in the children's safe mode. For this purpose, the output data is stored in a memory of the mobile communication device together with a lookup table in which each key of the keypad is associated with a specific output file. The output files associated with different keys would most often differ from each other, so that a child handling the mobile communication device is provided with some variety.

In another embodiment, the mobile communication device is configured to cause arbitrarily selected output data to be provided in response to pressing any key, when the children's safe operating mode is activated. The child therefore is provided with a variety of output data even when repeatedly pressing the same key, which is a typical behavior for very small children.

The present invention can operate with many kinds of output data. Typical output data for a display may include, e.g., pictures, animation, texts or video. Typical output data for a speaker typically includes audio sequences. If the output device is a vibrator, the output data may include a vibrating sequence to be applied to the vibrator. Accordingly, the output data advantageously can include visual data, in particular a digital image or video sequence, audio data or a vibrating sequence.

For children at a certain age, for example at age four years and up, the mobile communication device can advantageously provide access to games in the children's safe mode. For this purpose, games especially configured for children of a given age can be installed on the mobile communication device that can be played in the children's safe mode. If games are already part of the standard features of the mobile communication device, access to these games may be allowed when the children's safe mode is activated.

Typically, it is not intended that the child be able to deactivate the children's safe mode of the mobile communication device, thereby reversing the mobile communication device to a normal operating mode. Therefore, in one embodiment, the children's safe operating mode is deactivatable only by entering a pre-defined deactivation code via an input device of the mobile communication device, such as, for example, a personal identification number pre-selected by the mobile communication device's owner. Alternatively, deactivation may advantageously be performed by pressing a pre-defined combination of keys on an integrated keypad in a chord fashion. Although a key combination is less secure, it has the advantage of being easier and faster to enter.

The mobile communication device may be provided with at least first and second user-activatable children's safe operating modes. In such case, the mobile communication device may be configured to provide different pre-defined output data in response to user input in the first and second children's safe operating modes, respectively.

Different children's safe operating modes may advantageously be configured for children of different ages by providing different output data tailored to fit the respective age. For example, for children aged two, the corresponding children's safe operating mode may advantageously provide different music, images or movies as output data associated to each keystroke and may provide output data independent of which keys are pressed, and for children aged four the corresponding children's safe operating mode may include some simple games and may tie output data to specific keys.

Known keypad lock functions typically are disabled on detection of an incoming call. However, for a child it is typically not intended to accept incoming calls. The mobile communication device therefore may advantageously be configured to accept an incoming call only by entering a pre-defined code or by pressing a pre-defined combination of keys when the children's safe operating mode is activated. Alternatively, the children's safe mode may be required to be deactivated before accepting the incoming call.

Described herein is another aspect of the present invention that takes the form of a method for controlling a mobile communication device having a user input device, a user output device, a memory configured to store digital data and a transceiver configured to communicate with a second communication device. The method includes activating a user-activatable children's safe operating mode. The activating brings about an inhibiting of user-activation of the transceiver, an inhibiting of user-alteration of user-defined data stored in the memory and a causing of the output device to provide pre-defined output data retrieved from the memory in response to user input provided via the user input device.

User input may be provided by pressing a key on a keypad integrated in the mobile communication device. Alternatively or additionally, user input could be provided by recording speech or sounds by means of an integrated microphone. The recording can then be used as output data, so that for example the child can hear himself or herself speaking or his or her parent(s). An integrated camera could be used to provide input, for example by detecting movement or by capturing images which are then provided to an integrated display.

Certain embodiments of the method include retrieving output data from an integrated memory based on the key pressed or, in the alternative, arbitrarily selecting output data from a plurality of stored data files in response to any key pressed. The type of output data is essentially limited only by the output device(s) with which the mobile communication device is provided and by its storage capacity, and can for example include any one or more of a digital image, a video sequence, an audio sequence and a vibrating sequence or any combination thereof. The method may also include executing a game when the children's safe operating mode is activated.

The method may further include deactivating the children's safe operating mode by entering a pre-defined deactivation code or by pressing a pre-defined combination of keys on a keypad integrated in the mobile communication device.

Since a child playing with the mobile communication device as a toy is not intended to accept calls coming in while playing, the method further advantageously includes the step of accepting an incoming call only by first entering a pre-defined code or by pressing a pre-defined combination of keys on a keypad integrated in the mobile communication device.

The present invention may advantageously be embodied in a sequence of executable software or firmware instructions contained in a memory, such as an integrated circuit chip. Of course, dedicated hardware may be employed instead of or in addition to the software or firmware to achieve the same purposes.

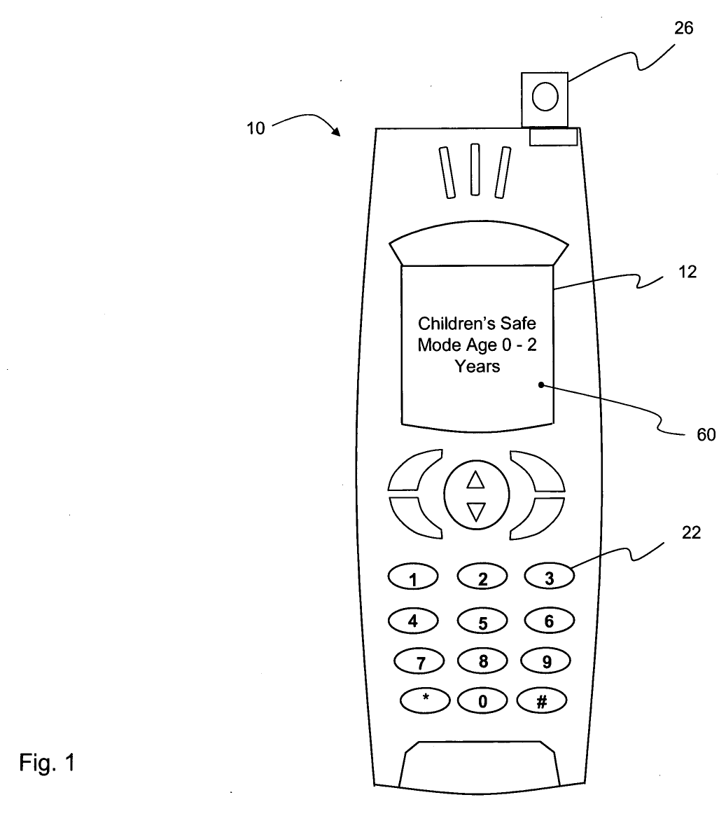

Reference will now be made to the FIGUREs to provide further detail regarding the various embodiments described herein. Accordingly, referring initially to FIG. 1, illustrated is a schematic front view of one embodiment of a mobile communication device capable of operating in a children's safe mode in accordance with the principles of the present invention.

FIG. 1 shows one embodiment of an inventive mobile communication device, taking the form of a mobile telephone 10. The mobile telephone 10 is equipped with a keypad 22 configured to accept user input and a display 12 configured to provide user output. Integrated in the mobile telephone 10 is a camera module 26. The mobile telephone 10 is provided with a children's safe operating mode which is indicated by corresponding information 60 on the display 12 when activated.

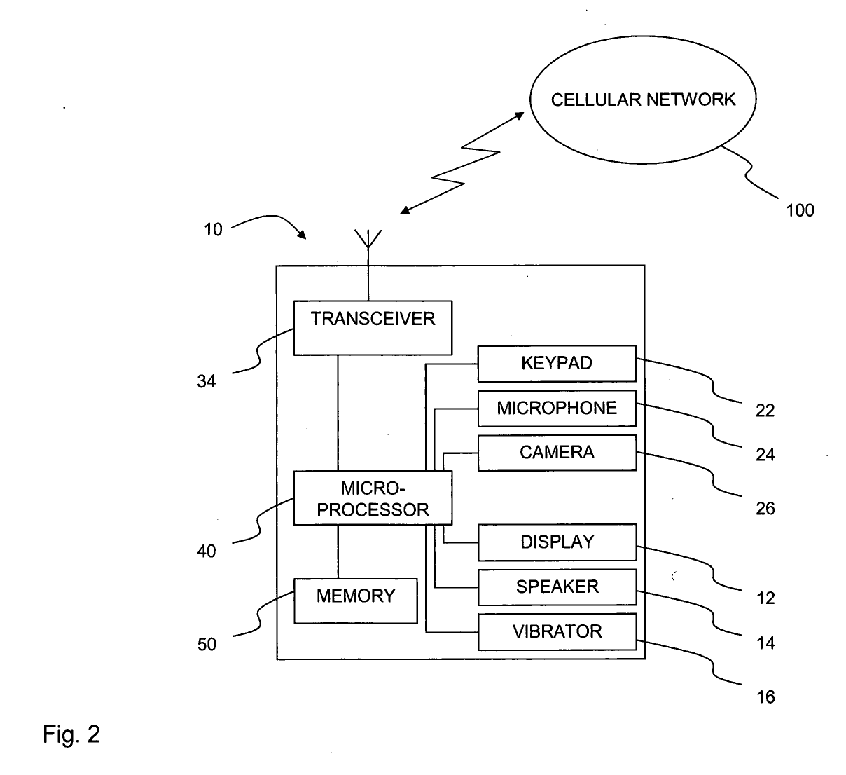

FIG. 2 illustrates a high-level block diagram of components of the mobile communication device of FIG. 1. For wireless communication purposes, the mobile telephone 10 includes a transceiver 34. The transceiver 34 enables communication via a cellular network 100. The mobile telephone 10 further employs a microprocessor 40 as a central controller. operating software, user-defined device settings, user data like phone directory entries or received and sent messages, and output data to be provided when the children's safe mode is activated are stored in a memory 50. The memory 50 can also include an exchangeable memory card with output data stored thereon, so that the output data for the children's safe operating mode may be flexibly configured according to user needs.

When the children's safe operating mode is activated, the normal use of the mobile telephone 10 is inhibited, in particular no telephone call can be placed or received via the transceiver 34, and no user data stored in memory 50 can be altered, unless the children's safe mode is first deactivated. The deactivation routine, for example entering a user-defined code or pressing a certain key combination, is such that a child would not be expected to be able to perform it intentionally or accidentally. To make the mobile telephone 10 attractive for a child to be used as a toy in the children's safe operating mode, the mobile telephone 10 responds to input from the child by providing suitable output.

In the embodiment of FIG. 2, the mobile telephone 10 provides multiple input devices, including the keypad 22, a microphone 24 and the camera 26. In the children's safe operating mode, the mobile telephone 10 may be configured to generate output in response to any input received from a child handling the mobile telephone 10 via any input device.

The mobile telephone 10 also provides multiple output devices, including the display 12, a speaker 14 and a vibrator 16, so that a variety of output data, including digital images, video clips, movies, sounds, music and vibration sequences can be provided to keep the child entertained.

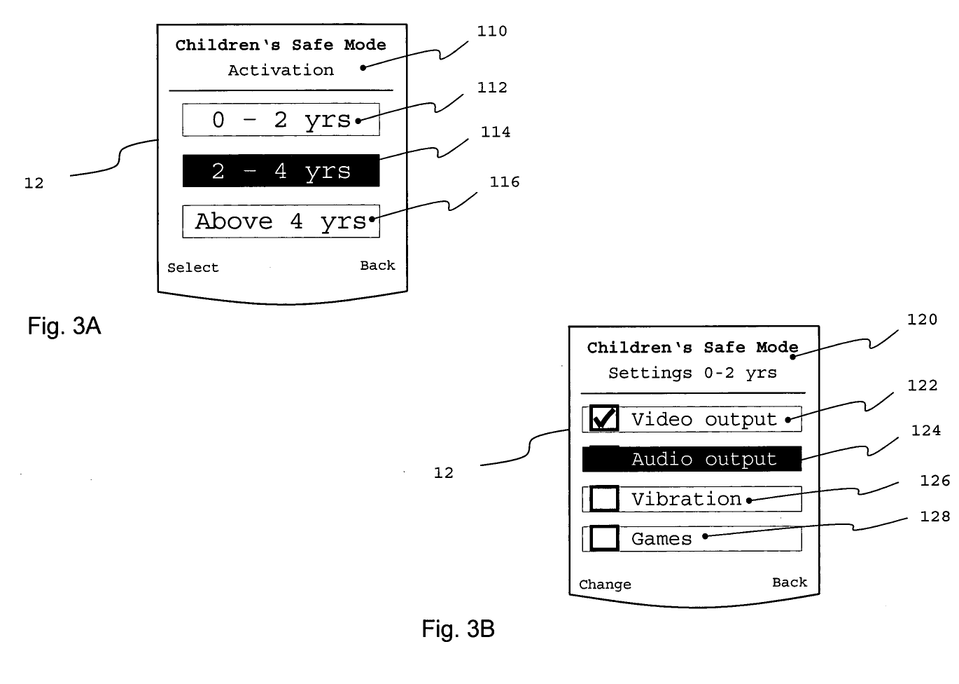

In one embodiment, different children's safe operating modes are provided for children of different age. Turning now to FIG. 3A, illustrated is a display of the mobile communication device of FIG. 1 showing a first screen associated with one embodiment of a children's safe mode carried out in accordance with the principles of the present invention. In the embodiment of FIG. 3A, the user can select among three children's safe modes respectively configured for children aged 0-2 years (via a menu pick line 112), aged 2-4 years (via a menu pick line 114) and aged 4 years and up (via a menu pick line 116). The user interface for activating one of these children's safe operating modes is provided with a selection heading 110, displayed at the top of the display 12.

In the illustrated embodiment, the user may separately configure each children's safe operating mode by defining certain parameters. For example, the user may select between different types of output data and whether games should or should not be available in the respective children's safe operating mode. Accordingly, turning now to FIG. 3B, illustrated is a display of the mobile communication device of FIG. 1 showing a second screen associated with one embodiment of a children's safe mode carried out in accordance with the principles of the present invention. FIG. 3B depicts the display 12 showing an exemplary user interface for adjusting the children's safe mode for children aged 0-2 years, as indicated by a corresponding display heading 120. In this embodiment the user can selectively activate the output of video data (via a menu pick line 122), the output of audio data (via a menu pick line 124), vibration as output (via a menu pick line 126) and access to games (via a menu pick line 128).

Of course, also any other configuration options may be offered further to define the behavior of the children's safe operating mode. The number of available children's safe operating modes may also be user-configurable.

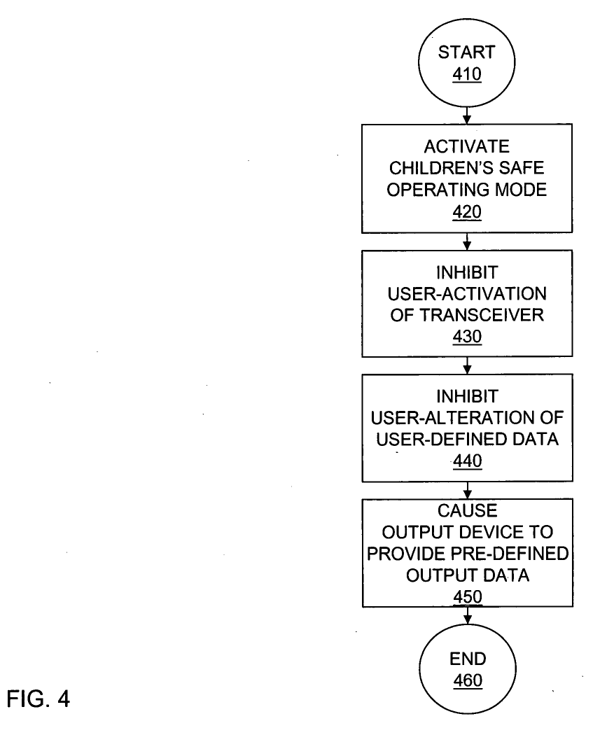

Turning now to FIG. 4, illustrated is a flow diagram of one embodiment of a method of controlling a mobile communication device to provide a children's safe mode in accordance with the principles of the present invention. The method begins in a start step 410, wherein it is desired to place the mobile communication device in the children's safe mode. In a step 420, the user-activatable children's safe operating mode is activated. Activation may be by way of a sequence of keystrokes (a code) or a particular combination of keys as a chord.

In a step 430, user-activation of the transceiver is inhibited. In a step 440, user-alteration of user-defined data stored in the storage device is inhibited. In a step 450, the output device is caused to provide pre-defined output data retrieved from the storage device in response to user input provided via the user input device. As stated above, the pre-defined output data may be visual, auditory or vibratory. The output data may be selected based on particular keys pressed or selected independently of which keys are pressed. The method ends in an end step 460. In the illustrated embodiment, the children's safe mode may be exited and normal operation restored by pressing a sequence of keystrokes or by pressing a combination of keys.

Although the present invention has been described in detail, those skilled in the pertinent art should understand that they can make various changes, substitutions and alterations herein without departing from the spirit and scope of the invention in its broadest form.

What is claimed is:

1. A mobile communication device having a user input device, a user output device, a storage device configured to store digital data and a transceiver configured to communicate with a second communication device, said mobile communication device comprising:
a user-activatable children's safe operating mode in which said mobile communication device is configured to:
inhibit user-activation of said transceiver,
inhibit user-alteration of user-defined data stored in said storage device, and
cause said output device to provide pre-defined output data retrieved from said storage device in response to user input provided via said user input device.

2. The mobile communication device as recited in claim 1 wherein said mobile communication device is selected from the group consisting of:
a mobile telephone,
a PDA, and
an MDA.

3. The mobile communication device as recited in claim 1 wherein said input device comprises a keypad having keys, each of said keys associated with different portions of said pre-defined output data, and, in said children's safe operating mode, said mobile communication device is configured to cause output of said pre-defined output data in response to pressing a corresponding key of said keypad.

4. The mobile communication device as recited in claim 1 wherein said input device comprises a keypad having keys and, in said children's safe operating mode, said mobile communication device is configured to cause said output device to provide arbitrarily selected output data in response to pressing any key of said keypad.

5. The mobile communication device as recited in claim 1 wherein said output device comprises a display and said pre-defined output data comprises visual data including at least a digital image.

6. The mobile communication device as recited in claim 1 wherein said output device comprises a speaker and said pre-defined output data comprises audio data.

7. The mobile communication device as recited in claim 1 wherein said output device comprises a vibrator and said pre-defined output data comprises a vibrating sequence.

8. The mobile communication device as recited in claim 1 wherein said mobile communication device is further configured to execute a game in said children's safe operating mode.

9. The mobile communication device as recited in claim 1 wherein said children's safe operating mode is deactivatable by entering a pre-defined deactivation code via said input device.

10. The mobile communication device as recited in claim 1 wherein said input device comprises a keypad and said children's safe operating mode is deactivatable by pressing a pre-defined combination of keys of said keypad.

11. The mobile communication device as recited in claim 1 wherein said mobile communication device is provided with at least first and second user-activatable children's safe operating modes and is configured to cause output of different pre-defined output data in response to user input in said first and second children's safe operating modes, respectively.

12. The mobile communication device as recited in claim 1 wherein said mobile communication device is configured to accept an incoming call only by entering a pre-defined deactivation code via said input device when said children's safe operating mode is activated.

13. The mobile communication device as recited in claim 1 wherein said mobile communication device is configured to accept an incoming call only by pressing a pre-defined combination of keys on a keypad integrated in said mobile communication device when said children's safe operating mode is activated.

14. A method of controlling a mobile communication device having a user input device, a user output device, a storage device configured to store digital data and a transceiver configured to communicate with a second communication device, comprising:
activating a user-activatable children's safe operating mode, said activating:
inhibiting user-activation of said transceiver,
inhibiting user-alteration of user-defined data stored in said storage device, and
causing said output device to provide pre-defined output data retrieved from said storage device in response to user input provided via said user input device.

15. The method as recited in claim 14 wherein said user input device comprises a keypad integrated in said mobile communication device.

16. The method as recited in claim 15 wherein said pre-defined output data is retrieved based on which keys of said keypad are pressed.

17. The method as recited in claim 15 wherein said pre-defined output data is retrieved irrespective of which keys of said keypad are pressed.

18. The method as recited in claim 14 wherein said retrieved output data is selected from the group consisting of:
a digital image,
a video sequence,
an audio sequence, and
a vibrating sequence.

19. The method as recited in claim 14 further comprising executing a game in said children's safe operating mode.

20. The method as recited in claim 15 further comprising deactivating said children's safe operating mode by entering a pre-defined deactivation code or pressing a pre-defined combination of keys on said keypad.

21. The method as recited in claim 15 further comprising accepting an incoming call by entering a pre-defined deactivation code or pressing a pre-defined combination of keys on said keypad.
